(19) United States
(12) Patent Application Publication
(10) Pub. No.: US 2005/0094908 A1
(43) Pub. Date: May 5, 2005

(54) Fluid dynamic bearing motor

(75) Inventor: Sang Uk Kim, Seoul (KR)

Correspondence Address: Robert E. Krebs;THELEN REID & PRIEST LLP, P.O. BOX 640640, SAN JOSE, CA, 95164-0640, US

(73) Assignee: G & W Technologies, Inc.

(21) Appl. No.: 10/981,961

(22) Filed: Nov. 4, 2004

(30) Foreign Application Priority Data
Nov. 5, 2003 (KR) 2003-78039
Jun. 16, 2004 (KR) 2004-44497

(51) Int. Cl. F16C 32/06

(52) U.S. Cl. 384/107

(57) ABSTRACT

Provided is a fluid dynamic bearing motor that can reduce vibration, oil deterioration, and power consumption by employing at least one pair of thrust bearings on upper and lower portions of a shaft. The fluid dynamic bearing motor includes: a housing to which a core with a coil wound around it, a sleeve having an axial hole at a central portion thereof, and a cover block supporting the sleeve are fixed; a shaft rotatably inserted into the axial hole to form an oil gap with the hole; a hub fixed to an upper end portion of the shaft and having a downwardly extending portion to an inner surface of which a magnet generating an electromagnetic force through an interaction with the core is attached; and circular thrust plates respectively fixed to upper and lower portions of the shaft, wherein receiving grooves are formed on an inner portion of the sleeve and accommodate the thrust plates to form fluid dynamic bearing surfaces. Since the fluid dynamic bearing motor employs the thrust fluid dynamic bearings on the upper and lower portions of the shaft, conical vibration of the shaft is prevented and heat generation and power consumption are reduced. Furthermore, since the fluid dynamic bearing motor employs the hydrodynamic pressure cover, oil leakage is prevented and an internal pressure of the fluid dynamic bearing is enhanced.

### BACKGROUND OF THE INVENTION

This application claims the priority of Korean Patent Application Nos. 2003-78039, filed on Nov. 5, 2003 and 2004-44497, filed on Jun. 16, 2004, in the Korean Intellectual Property Office, the disclosures of which are incorporated herein by reference.

1. Field of the Invention

The present invention relates to a fluid dynamic bearing motor, and more particularly, to a fluid dynamic bearing motor that can reduce vibration, oil deterioration, and power consumption by employing at least one pair of thrust bearings on upper and lower portions of a shaft. Further, the present invention relates to a fluid dynamic bearing motor that has an improved load support force to bear the load of a plurality of platters for recording and/or collecting a great amount of information.

2. Description of the Related Art

In general, friction between the ball bearings of a motor and shafts causes noise and vibration. Such vibration can cause a non-repeatable run out (NRRO), which does not allow higher track density of a hard disk.

Fluid dynamic bearings, however, are based on a centrifugal force such that a motor shaft does not come in contact with other metallic elements due to a hydrodynamic pressure of lubricant oil caused by the centrifugal force, thereby causing no metal friction, achieving high stability during a high speed rotation, and ensuring low noise and vibration. Further, since fluid dynamic bearings permit a disk to rotate fast as compared with ball bearings, the fluid dynamic bearings are suitable for high-end hard disk products.

A fluid dynamic bearing employed in a spindle motor is generally configured such that herringbone or spiral hydrodynamic pressure generating grooves are formed on an inner surface of a sleeve or on top and bottom surfaces of a thrust plate and oil is filled in a narrow bearing clearance formed between a shaft and the sleeve or between the thrust plate and the sleeve. Consequently, the elements, which may cause friction, are separated from one another due to a hydrodynamic pressure generated in the bearing clearance, and a friction load is reduced.

A spindle motor employing such a fluid dynamic bearing is illustrated in FIG. 1.

A motor in which a shaft rotates includes a fixing member constituted by a housing 10, a sleeve 20, and a core, and a rotating member constituted by a shaft 40, a hub 50, and a magnet 60.

The sleeve 20 is of a hollow type such that the shaft 40 is rotatably inserted into the sleeve 20. Hydrodynamic pressure generating grooves (not shown) are formed on an inner surface of the sleeve 20 to generate a hydrodynamic pressure in a radial direction of the shaft 40.

In particular, an inner portion of the sleeve 20 is formed so that a circular ring-shaped thrust plate 70 can be rotatably coupled to a lower end portion of the shaft 40 to rotate together with the shaft 40. The core 30 with a coil wound around it is fixed to a centeral portion in the housing 10.

The thrust plate 70 has hydrodynamic pressure generating grooves (not shown) formed on top and bottom surfaces thereof to generate a hydrodynamic pressure in an axial direction.

In the meantime, a lower end portion of the sleeve 20 is shielded by a cover plate 80 such that the sleeve 20 is isolated from the outside. The thrust plate 70 is rotatably disposed on the cover plate 80.

The hub 50 is integrally formed with a top end of the shaft 40 that is pivotably inserted into the inner portion of the sleeve 20. The hub 50 has a cap shape opened downward. The magnet 60 is installed on an inner surface of an extending portion of the hub 50 to face an outer surface of the core 30.

In this structure, narrow oil gaps are formed between the inner surface of the sleeve 20 and the shaft 40 and between the inner surface of the sleeve 20 and the thrust 70. Oil having predetermined viscosity is filled in the oil gaps.

When the shaft 40 rotates, the oil filled in the oil gaps converges into the hydrodynamic pressure generating grooves of the sleeve 20 and the hydrodynamic pressure generating grooves of the thrust 70. Accordingly, the oil gaps are always maintained constant, and thus, the shaft 40 can be driven stably.

In the conventional shaft rotating-type fluid dynamic bearing motor, if external power is supplied to the core 30, the hub 50 to which the magnet 60 is attached rotates due to an electromagnetic force between the core 30 and the magnet 60. Accordingly, the shaft 40 coupled to the hub 50 rotates at the same time.

When the fluid dynamic bearing motor is driven, the shaft 40 inserted into the inner portion of the sleeve 20 can smoothly rotate in non-contact with the inner surface of the sleeve 20 due to a hydrodynamic pressure generated in the hydrodynamic pressure generating grooves (not shown) formed on the inner surface of the sleeve 20 and an outer surface of the shaft 40.

That is, a sufficient amount of oil is supplied between the outer surface of the shaft 40 and the inner surface of the sleeve 20, such that oil flows along the hydrodynamic pressure generating grooves (not shown) formed on the inner surface of the sleeve 20 to produce a hydrodynamic pressure when the shaft 40 rotates. Consequently, a rotation load can be minimized and a smooth high speed rotation can be achieved.

However, the spindle motor employing the fluid dynamic bearing has the following problems.

First, since one thrust plate 70 is coupled to the lower end portion of the shaft 40, conical vibration occurs such that the shaft 40 severely rotates about the thrust plate 70 in a large circle.

If a rotating body is tilted and a clearance between the body and another element is narrowed, a high pressure is caused and the rotating body returns to its original position due to this pressure. However, if the rotating body is excessively tilted, a hydrodynamic pressure change increases, and vibration, such as NRRO, increases.

Specifically, if the upper and lower end portions of the sleeve 20 and the shaft 40 are misaligned due to a clearance caused by a tolerance when assembling the sleeve 20, the shaft 40, and the thrust 70, the NRRO increases.

Second, when the fluid dynamic bearing motor continuously operates, heat is produced. Particularly, much heat is produced in the thrust plate 70 that moves with a high speed relative to the sleeve 20. Accordingly, the heat produced in the thrust plate 70 that forms a fluid dynamic bearing surface results in a temperature rise, such that the viscosity of oil decreases and a load support force of the fluid dynamic bearing is reduced.

Furthermore, as the load support force is reduced, a clearance between fluid dynamic bearing surfaces is further narrowed, thereby increasing the amount of generated heat.

For the purpose of reducing heat generation, the size of the thrust plate 70 should be reduced to reduce a speed difference between the thrust plate 70 and the sleeve 20. However, the reduced size of the thrust plate 70 leads to a deterioration of the load support force, thereby making a stable rotation impossible.

Third, a great quantity of air bubbles are present in the oil supplied to the bearing clearance. The air bubbles are expanded as the temperature rises due to a frictional heat generated in the bearing clearance at an initial operation. The expanded air bubbles push the oil away from the bearing clearance, thereby causing oil leakage.

Particularly, in the conventional fluid dynamic bearing motor, since the upper end portion of the sleeve 20 that forms a fluid dynamic bearing surface with the shaft 40 is exposed to the outside, there is a risk that the oil between the sleeve 20 and the shaft 40 may leak out.

Fourth, when a high capacity hard disk drive (HDD) is realized by increasing the number of platters that is coupled to and rotate along with the hub 50, the load of the rotating body, for example, the hub 50 or the shaft 40, increases, thereby causing vibration.

### SUMMARY OF THE INVENTION

The present invention provides a fluid dynamic bearing motor that can ensure a stable rotation by minimizing conical vibration of a shaft.

The present invention provides a fluid dynamic bearing motor that can improve bearing performance by minimizing heat generation during operation.

The present invention provides a fluid dynamic bearing motor that has an improved structure to reduce power consumption.

The present invention provides a fluid dynamic bearing motor that can improve bearing performance by preventing oil from leaking out and increasing an internal pressure.

The present invention provides a fluid dynamic bearing motor that can collect very tiny air bubbles generated there in operation and store oil.

The present invention provides a fluid dynamic bearing motor that can improve a load support force such that a stable operation can be performed although a high capacity drive is realized by increasing the number of platters that are coupled to and rotate together with a hub.

According to an aspect of the present invention, there is provided a fluid dynamic bearing motor comprising: a housing to which a core with a coil wound around it, a sleeve having an axial hole at a central portion thereof, and a cover block supporting the sleeve are fixed; a shaft rotatably inserted into the axial hole to form an oil gap with the hole; a hub fixed to an upper end portion of the shaft and having a downwardly extending portion to an inner surface of which a magnet generating an electromagnetic force through an interaction with the core is attached; and circular thrust plates respectively fixed to upper and lower portions of the shaft, wherein receiving grooves are formed on an inner portion of the sleeve and accommodate the thrust plates to form fluid dynamic bearing surfaces.

The fluid dynamic bearing motor may further comprise a hydrodynamic pressure cover fixed to an upper end of the inner portion of the sleeve such that the shaft is rotatably coupled to the hydrodynamic pressure cover, the hydrodynamic pressure cover forming an oil gap with the upper thrust plate and having a plurality of inclined grooves formed at regular intervals on an inner portion thereof.

The fluid dynamic bearing motor may further comprise fluid passage grooves formed on top and bottom surfaces of the upper and lower thrust plates or on the sleeve and the hydrodynamic pressure cover corresponding to the top and bottom surfaces to generate a hydrodynamic pressure by forming oil passages. The fluid passage grooves may have a herringbone or spiral shape.

The fluid dynamic bearing motor may further comprise oil grooves formed on inner portions of the upper and lower thrust plates to collect air bubbles between the inner portions and the shaft.

The hub may be integrally formed with the upper end portion of the shaft. The fluid dynamic bearing motor may further comprise: an inwardly extending hollow flange formed at a central portion of the housing and having an outer circumferential surface to which the core is fixed; and a cover block inserted into a hollow space of the flange and supporting lower end portions of the shaft, the lower thrust plate, and the hub.

The fluid dynamic bearing motor may further comprise: an annular rib formed on a top surface of the cover block and having an accommodating groove that accommodates the lower end portion of the shaft and the lower thrust plate; and a coupling groove formed on the lower end portion of the sleeve and allowing the annular rib to be coupled thereto.

According to another aspect of the present invention, there is provided a fluid dynamic bearing motor comprising: a housing having an inwardly extending hollow flange formed at a central portion thereof; a core fixed to an outer circumferential surface of the flange and having a coil wound around it; a cover block inserted into a hollow space of the flange and having an upper end portion protruding into the housing; a sleeve having a lower end portion fixed to the cover block and also having an axial hole at a central portion thereof; a shaft rotatably inserted into the axial hole to form an oil gap with the hole; a hub integrally formed with an upper end portion of the shaft and having a downwardly extending portion to an inner surface of which a magnet generating an electromagnetic force through an interaction with the core is attached; a circular upper thrust plate fixed to an upper portion of the shaft to rotate together with the shaft and having top and bottom surfaces on which fluid passage grooves are formed to generate a fluid dynamic pressure between the upper thrust plate and the sleeve; a circular lower thrust plate fixed to a lower portion of the shaft to rotate together with the shaft and having top and bottom surfaces on which fluid passage grooves are formed to generate a fluid dynamic pressure between the sleeve and a top surface of the cover block; a hydrodynamic pressure cover fixed to an upper end of an inner portion of the sleeve such that the shaft is rotatably coupled to the hydrodynamic pressure cover, the hydrodynamic pressure cover forming an oil gap with a top surface of the upper thrust plate and having a plurality of inclined grooves formed at regular intervals on an inner portion thereof; and receiving grooves formed on the inner portion of the sleeve and accommodating the upper and lower thrust plates to form fluid dynamic bearing surfaces.

According to still another aspect of the present invention, there is provided a fluid dynamic bearing motor comprising: a housing having an inwardly extending hollow flange formed at a central portion thereof; a core fixed to an outer circumferential surface of the flange and having a coil wound around it; a cover block inserted into a hollow space of the flange and having an upper end portion internally protruding into the housing, the cover block also having a tap surface on which an annular rib forming an accommodating groove is formed; a sleeve having a lower end portion on which a coupling groove coupled to the annular rib of the cover block is formed and having an axial hole at a central portion thereof; a shaft rotatably inserted into the axial hole to form an oil gap with the hole and having upper and lower portions on outer circumferential surfaces of which flow grooves are formed to generate a fluid dynamic pressure; a hub integrally formed with an upper end portion of the shaft and having a downwardly extending portion to an inner surface of which a magnet generating an electromagnetic force through an interaction with the core is attached; a circular upper thrust plate fixed to an upper portion of the shaft to rotate together with the shaft and having top and bottom surfaces on which fluid passage grooves are formed to generate a fluid dynamic pressure between the upper thrust plate and the sleeve by forming oil passages; a circular lower thrust plate fixed to a lower portion of the shaft to rotate together with the shaft and having top and bottom surfaces on which fluid passage grooves are formed to generate a fluid dynamic pressure between the sleeve and a top surface of the cover block by forming oil passages; a hydrodynamic pressure cover fixed to an upper end of an inner portion of the sleeve such that the shaft is rotatably coupled to the hydrodynamic pressure cover, the hydrodynamic pressure cover forming an oil gap with a top surface of the upper thrust plate and having inclined grooves at regular intervals formed on an inner portion thereof; and receiving grooves formed on the inner portion of the sleeve and accommodating the upper and lower thrust plates to form fluid dynamic bearing surfaces.

According to yet another aspect of the present invention, there is provided a shaft fixed-type fluid dynamic bearing motor comprising: a housing to an inner central portion of which an annular stator is fixed; a shaft having one end fixed to a center of the housing; a sleeve rotatably coupled to the shaft to form an oil gap with the shaft; a hub having a central portion coupled to the sleeve to rotate together with the sleeve and also having a downwardly extending portion to an inner surface of which a rotor generating an electromagnetic force through an interaction with the stator is attached; and circular first and second thrust plates respectively fixed to upper and lower portions of the shaft and forming fluid dynamic bearing surfaces between the first and second thrust plates and the sleeve.

The fluid dynamic bearing motor may further comprise: a cover plate fixed to an upper end portion of the sleeve to face the first thrust plate, and rotatably supported on an upper end portion of the shaft; and an annular lower hydrodynamic pressure cover fixed to a lower end portion of the shaft to face the second thrust plate.

The upper end portion of the shaft may be fixed to a fixed body such that both ends of the shaft are fixed.

The cover plate may be of an annular shape and have an inner surface or a corresponding surface on which flow grooves are formed such that the upper end portion of the shaft can pass through the cover plate, and the upper end portion of the shaft may be fixed to a fixed body such that both ends of the shaft are fixed.

The annular lower hydrodynamic pressure cover may have an upwardly extending portion along an edge thereof, and the sleeve may have an accommodating groove in which the extending portion is accommodated such that a journal fluid dynamic bearing and a thrust fluid dynamic bearing are formed between the sleeve and the extending portion.

Since the fluid dynamic bearing motor employs the thrust fluid dynamic bearings on the upper and lower portions of the shaft, conical vibration of the shaft is prevented and heat generation and power consumption are reduced. Furthermore, since the fluid dynamic bearing motor employs the hydrodynamic pressure cover, oil leakage is prevented and an internal pressure of the fluid dynamic bearing is enhanced.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic cross-sectional view of a conventional fluid dynamic bearing motor;

FIG. 2 is a schematic cross-sectional view of a fluid dynamic bearing motor according to an embodiment of the present invention;

FIG. 3 is a schematic view illustrating oil flowing during an operation of the fluid dynamic bearing motor shown in FIG. 2;

FIG. 4 is a cross-sectional view of a hydrodynamic pressure cover employed in the fluid dynamic bearing motor shown in FIG. 2;

FIG. 5 is a plan view of a thrust plate employed in the fluid dynamic bearing motor shown in FIG. 2;

FIG. 6 is a schematic view illustrating essential parts of the fluid dynamic bearing motor shown in FIG. 2;

FIG. 7 is a cross-sectional view of a fluid dynamic bearing motor according to another embodiment of the present invention;

FIG. 8 is a cross-sectional view of a fluid dynamic bearing motor according to still another embodiment of the present invention;

FIG. 9 is a schematic view illustrating essential parts of the fluid dynamic bearing motor shown in FIG. 8;

FIG. 10 is a schematic cross-sectional view of a fluid dynamic bearing motor according to yet another embodiment of the present invention;

FIG. 11 is a cross-sectional view of a fluid dynamic bearing motor according to a further embodiment of the present invention;

FIG. 12 is a cross-sectional view of a fluid dynamic bearing motor according to another embodiment of the present invention;

FIG. 13 is a cross-sectional view of an upper hydrodynamic pressure cover employed in the motors shown in FIGS. 11 and 12; and

FIG. 14 is a cross-sectional view of a lower hydrodynamic pressure cover employed in the motor shown in FIG. 12.

### DETAILED DESCRIPTION OF THE INVENTION

A fluid dynamic bearing motor employs both a journal fluid dynamic bearing, which is generated at a journal portion of a shaft facing a sleeve, and a thrust fluid dynamic bearing.

In particular, the fluid dynamic bearing motor employs one pair of thrust fluid dynamic bearings on upper and lower portions of the shaft. Accordingly, although the fluid dynamic bearing motor has the same load support force as an equivalent motor having one thrust fluid dynamic bearing, the fluid dynamic bearing motor prevents conical vibration of the shaft, and reduces heat generation and power consumption by reducing a speed of a thrust plate, which forms the thrust fluid dynamic bearing, relative to the sleeve.

Moreover, the fluid dynamic bearing motor has a hydrodynamic pressure cover for producing a hydrodynamic pressure coupled to an upper end portion of the sleeve to which the shaft is rotatably coupled, thereby increasing an internal pressure of a fluid dynamic bearing and effectively preventing oil leakage.

Further, an oil storage space or an air bubble collector where oil is stored and generated air bubbles are collected is disposed at a portion where a pressure is lower than other portions of the fluid dynamic bearing, thereby preventing an unstable operation due to expansion of the air bubbles as heat is produced.

The present invention will now be described more fully with reference to the accompanying drawings, in which preferred embodiments of the invention are shown.

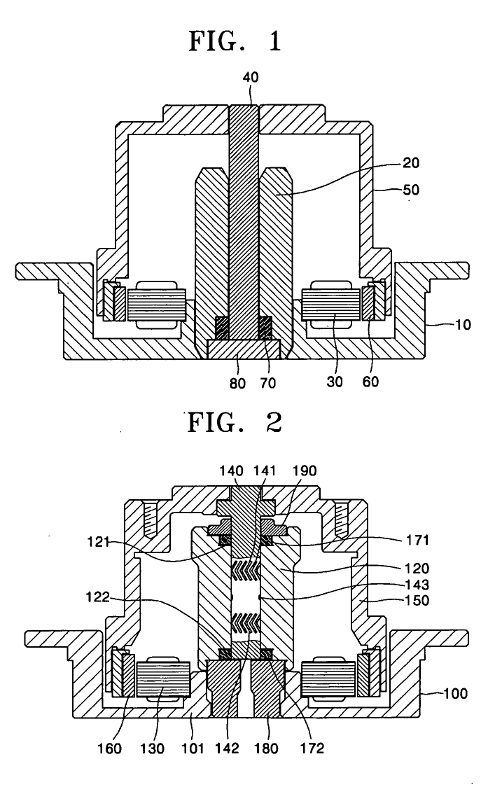

Referring to FIG. 2, a fluid dynamic bearing motor according to an embodiment of the present invention includes a housing 100 to which a sleeve 120 having an axial hole at a central portion thereof and a core 130 with a coil wound around it are fixed, a shaft 140 rotatably inserted into the axial hole to form an oil gap with the hole, a hub 150 fixed to an upper end portion of the shaft 140 and having a downwardly extending portion to an inner surface of which a magnet 160 generating an electromagnetic force through an interaction with the core 130 is attached, and circular thrust plates 171 and 172 respectively fixed to upper and lower portions of the shaft 140.

Further, an inwardly extending hollow flange 101 is formed at a central portion of the housing 100 and has an outer circumferential surface to which the core 130 is fixed, and a cover block 180 is inserted into a hollow space of the flange 101 and supports lower end portions of the shaft 140, the lower thrust plate 172, and the sleeve 120.

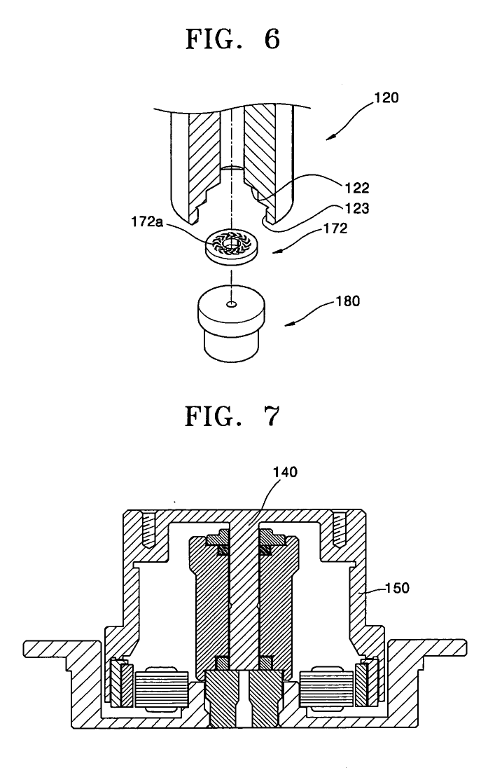

As shown in FIGS. 2 and 6, receiving grooves 121 and 122 are formed on an inner portion of the sleeve 120 and accommodate the upper and lower thrust plates 171 and 172 to form fluid dynamic bearing surfaces. A coupling groove 123 to which an upper end of the cover block 180 is coupled is also formed on the inner portion of the sleeve 120.

Flow grooves 141 and 142 are formed on upper and lower portions of an outer circumferential surface of the shaft 140 to form a fluid dynamic pressure using injected oil. Here, flow grooves may be formed on the inner portion of the sleeve 120 facing the flow grooves 141 and 142 to induce a fluid dynamic pressure.

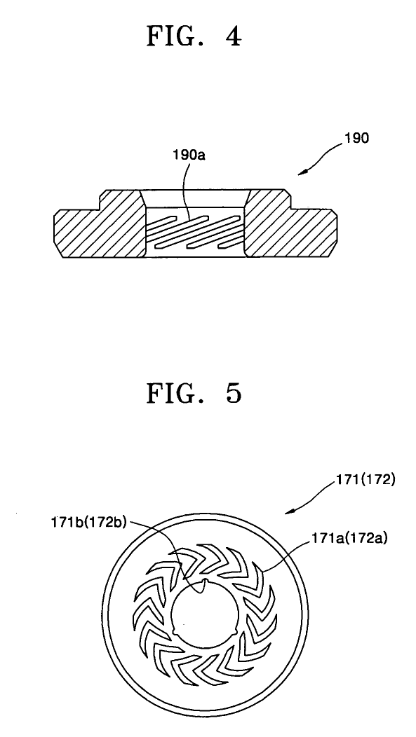

Referring to FIGS. 2 and 4, a hydrodynamic pressure cover 190 is disposed on an upper end of the inner portion of the sleeve 120 to increase an internal pressure of a journal portion and prevent oil leakage. The shaft 140 is rotatably coupled to the hydrodynamic pressure cover 190. The hydrodynamic pressure cover 190 forms an oil gap with a top surface of the upper thrust plate 171, and has a plurality of inclined grooves 190a formed at regular intervals at an inner portion thereof.

When the shaft 140 rotates relative to the hydrodynamic pressure cover 190, oil filled in the inclined grooves 190a flows toward lower end portions of the inclined grooves 190a where a pressure is high, thereby preventing oil leakage, increasing an internal pressure, and generating a stable fluid dynamic pressure.

In the meantime, as shown in FIG. 5, fluid passage grooves 171a and 172a are formed on top and bottom surfaces of each of the upper and lower thrust plates 171 and 172 to generate a hydrodynamic pressure by forming oil passages.

Further, fluid passage grooves may be formed on a bottom surface of the hydrodynamic pressure cover 190 and the sleeve 120, respectively, facing the top and bottom surfaces of the upper thrust plate 171 to form a hydrodynamic pressure by forming oil passages.

Furthermore, fluid passage grooves may be formed on a top surface of the cover block 180 and the sleeve 120, respectively, facing the bottom and top surfaces of the lower thrust plate 172 to generate a hydrodynamic pressure by forming oil passages.

The fluid passage grooves 171a and 172a may have a herringbone shape, as shown in FIG. 5, or a spiral shape.

On the other hand, as shown in FIG. 5, oil grooves 171b and 172b are formed on inner portions of the upper and lower thrust plates 171 and 172 to collect air bubbles between the oil grooves 171b and 172b and the shaft 140. The oil grooves 171b and 172b are disposed on the portions where a fluid dynamic pressure is relatively lower than others during the rotation of the shaft 140, such that generated air bubbles can be smoothly collected.

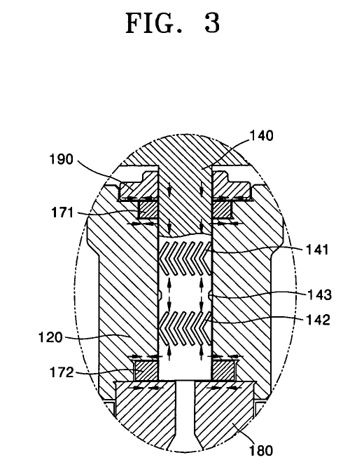

FIG. 3 illustrating an air flow when the shaft 140 rotates.

Actually, oil moves to a higher pressure point, and generated air bubbles move to a lower pressure point. That is, oil and air bubbles move in opposite directions.

That is, oil dynamically converges into the flow grooves 141 and 142 of the shaft 140 during the rotation of the shaft 140, such that a pressure at the flow grooves 141 and 142 increases. A pressure relatively decreases at an axial groove formed between the upper and lower thrust plates 171 and 172 and the flow grooves 141 and 142 of the shaft 140.

Accordingly, tiny air bubbles generated during the rotation of the shaft 140 are stored in the oil grooves 171b and 172b of the upper and thrust plates 171 and 172 where a pressure is low.

If the core 130 of he fluid dynamic bearing motor constructed as above is turned on, a rotating member constituted by the shaft 140, the hub 150, and the magnet 160 begins to rotate relative to a fixing member constituted by the housing 100, the sleeve 120, and the core 130.

Oil filled between the fixed sleeve 120 and the rotating shaft 140 converges into the flow grooves 141 and 142 to form a high pressure and a fluid dynamic bearing.

Further, a fluid dynamic bearing in a thrust direction is formed between the upper and lower thrust plates 171 and 172 and the sleeve 120.

The shaft 140 can smoothly rotate by virtue of the fluid dynamic bearing formed on the flow grooves 141 and 142 and the fluid dynamic bearing in the thrust direction.

Further, since oil at the inclined grooves 190a of the rotating hydrodynamic pressure cover 190 flows downwardly, an internal pressure between the sleeve 120 and the shaft 140 increases and oil leakage is prevented.

On the other hand, oil flowing in the oil gaps due to the relative rotation of the shaft 140 forms fluid passages in the direction indicated by arrows as shown in FIG. 3. That is, a high pressure is generated at the flow grooves 141 and 142 of the shaft 140 to form the fluid dynamic bearing, and a relatively low pressure is formed at the axial groove 143 formed on a central portion of the shaft 140 and at the upper and lower thrust plates 171 and 172 to collect generated micro air bubbles. At this time, the air bubbles are collected in the oil grooves 171b and 172b of the thrust plates 171 and 172.

The fluid dynamic bearing motor according to the present embodiment employs one pair of thrust fluid dynamic bearings made by the upper and lower thrust plates 171 and 172. Consequently, the fluid dynamic bearing motor can have the same load support force and smaller thrust plates 171 and 172 as compared with an equivalent motor having one fluid dynamic bearing.

Therefore, when outer diameters of the upper and lower thrust plates 171 and 172 decrease, the speed of the shaft relative to the sleeve is reduced, thereby reducing heat generation and power consumption.

In the meanwhile, the geometrical relation among power consumption, heat generation, and a thrust fluid dynamic bearing are expressed as follows.
P=C(N²R⁵/H²)

where P denotes power consumption or heat generation, H denotes a thrust fluid dynamic bearing clearance, N denotes the number of rotations, R denotes a radius of a thrust fluid dynamic bearing, and C denotes a proportional constant.

Accordingly, power consumption and heat generation are proportional with the number of the thrust plates 171 and 172. Thus, it is advantageous that the radii of the thrust plates 171 and 172 and the number of the thrust plates 171 and 172 are reduced to reduce power consumption and heat generation.

In the meantime, if the radii of the thrust plates 171 and 172 are reduced, a load support force and a bearing stiffness coefficient are reduced. The relations among the radii of the thrust plates 171 and 172, the stiffness coefficient, and the load support force are expressed as follows.
K=C(NR⁴/H³), W=C(NR⁴/H²)

where K denotes a stiffness coefficient, W denotes a load support force, and C denotes a proportional constant.

Referring to the above equation, power consumption relates to the 5th power of the radius of each of the thrust plates 171 and 172, and the stiffness coefficient and the load support force are proportional to the 4th power of the radius. Accordingly, if two thrust plates 171 and 172 are used and the radii of the thrust plates 171 and 172 are reduced as much as increased stiffness coefficient and load support force, the stiffness coefficient and the load support force remain as usual and only power consumption is reduced.

Accordingly, if the stiffness coefficient and the load support force are the same when one thrust plate is used and two thrust plates 171 and 172 are used, the following results are obtained.

TABLE 1

| Number of thrust | | Power | Load | Stiffness |
|---|---|---|---|---|
| fluid dynamic | | consumption | support | coefficient |
| bearings | Radius (μm) | (P) | force (N) | (N/m) |
| 1 | R | P | W | K |
| 2 | R*0.84 | P*0.42 | W | K |

Power consumption and heat generation of the motor using two thrust plates are 42% of those of the motor using one thrust plate.

Further, since the thrust plates 171 and 172 are installed on both ends of the shaft 140, the shaft 140 is less tilted with respect to the same conical vibration such that a local thrust fluid dynamic bearing clearance is less reduced, as compared with the motor using one thrust plate. Accordingly, a temperature rise is reduced and fluid properties do not deteriorate.

Referring to FIG. 7 illustrating a fluid dynamic bearing motor according to another embodiment of the present invention, an upper end portion of the shaft 140 is integrally formed with the hub 150. Accordingly, the motor can be conveniently assembled, the number of components and processes can be reduced, and the components can be more easily managed. Since other constructions of the fluid dynamic bearing motor illustrated in FIG. 7 are similar to those of the fluid dynamic bearing motor illustrated in FIG. 2, a detailed explanation thereof will not be given.

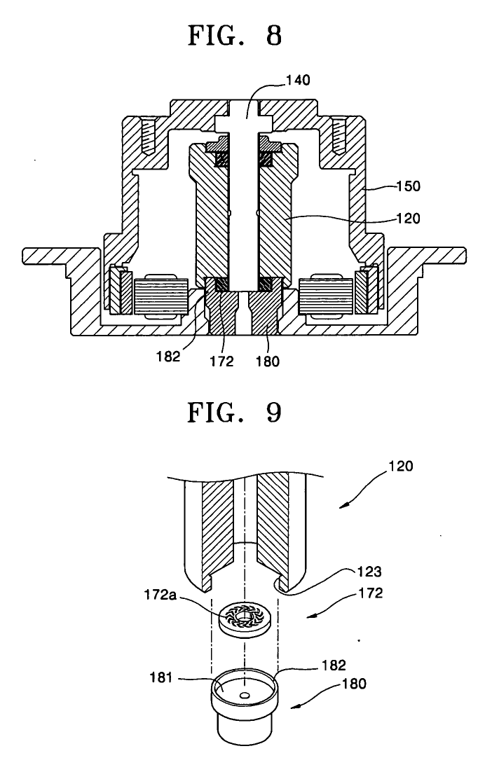

Referring to FIGS. 8 and 9 illustrating a fluid dynamic bearing motor according to still another embodiment of the present invention, an annular rib 182 is formed on a top surface of the cover block 180 to accommodate a lower end portion of the shaft 140 and the lower thrust plate 172. The annular rib 182 is coupled to the coupling groove 123 formed at a lower end portion of the sleeve 120.

The journal portion is lengthened without changing the size of the sleeve 120 and the hub 150, thereby improving a load support force.

Since other constructions of the fluid dynamic bearing motor illustrated in FIGS. 8 and 9 are similar to those illustrated in FIGS. 2 and 7, a detailed explanation thereof will not be given.

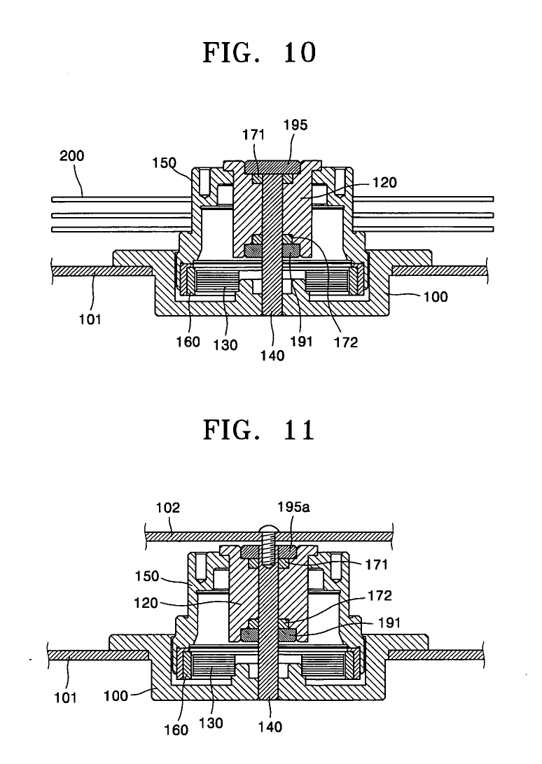

Fluid dynamic bearing motors according to other embodiments of the present invention will be explained with reference to FIGS. 10 through 14.

In the fluid dynamic bearing motors of the embodiments illustrated in FIGS. 10 through 14, one or both ends of the shaft are fixed. When the weight of a rotating body increases, such as when the number of platters increases, the motors using the shaft having one or two fixed ends have a higher load support force than a motor using a conventional shaft, thereby enabling a stable operation.

Further, the fluid dynamic bearing motors illustrated in FIGS. 10 through 14 employ one pair of thrust fluid dynamic bearings on upper and lower portions of the shaft. Accordingly, while the fluid dynamic bearing motors can have the same load support force as an equivalent motor employing one thrust fluid dynamic bearing, they can also prevent conical vibration of the shaft, and can reduce heat generation and power consumption by reducing the speed of the thrust plate, which forms a thrust fluid dynamic bearing, relative to the sleeve.

Since a cover plate and a lower hydrodynamic pressure cover for forming a fluid dynamic pressure are coupled to the upper and lower end portions of the sleeve into which the shaft is rotatably inserted, an internal pressure of the fluid dynamic bearing increases and oil leakage is effectively prevented.

The fluid dynamic bearing motors illustrated in FIGS. 10 through 14 will now be explained in detail.

Referring to FIG. 10, a fluid dynamic bearing motor includes the housing 100 to an inner central portion of which an annular stator 130 is fixed, the shaft 140 having one end fixed to a center of the housing 100, the sleeve 120 rotatably coupled to the shaft 140 to form an oil gap, the hub 150 having a central portion coupled to the sleeve 120 to rotate together with the sleeve 120 and also having a downwardly extending portion to an inner surface of which a rotor 160 generating an electromagnetic force through an interaction with the stator 130 is attached, and the annular first and second thrust plates 171 and 172 respectively fixed to upper and lower portions of the shaft 140 and forming fluid dynamic bearing surfaces between the first and second thrust plates 171 and 172 and the sleeve 120.

Reference 101 denotes a hard disk drive (HDD) case to which the housing 100 is fixed.

The stator 130 is a core having a coil wound therearound, and the rotor 160 is a magnet that generates an electromagnetic force through an interaction with the stator 130.

Further, a cover plate 195 is coupled to an upper end portion of the sleeve 120 to face the first thrust plate 171, and is rotatably supported on an upper end portion of the shaft 140. An annular lower hydrodynamic pressure cover 191 facing the second thrust plate 172 is fixed to a lower end portion of the shaft 140.

Referring to FIG. 11 illustrating a fluid dynamic bearing motor according to another embodiment of the present invention, a cover plate 195a fixed to the sleeve 120 has an annular shape such that the upper end portion of the shaft 140 can pass through the cover plate 195a. The upper end portion of the shaft 140 is fixed to a fixed body, namely, a case 102 in which the motor is accommodated. The present embodiment illustrated in FIG. 11 is characterized in that both the upper and lower end portions of the shaft 140 are fixed to the case 102 and the housing 100, respectively. Other elements of the motor are similar to those illustrated in FIG. 10, and thus, a detailed explanation will not be given.

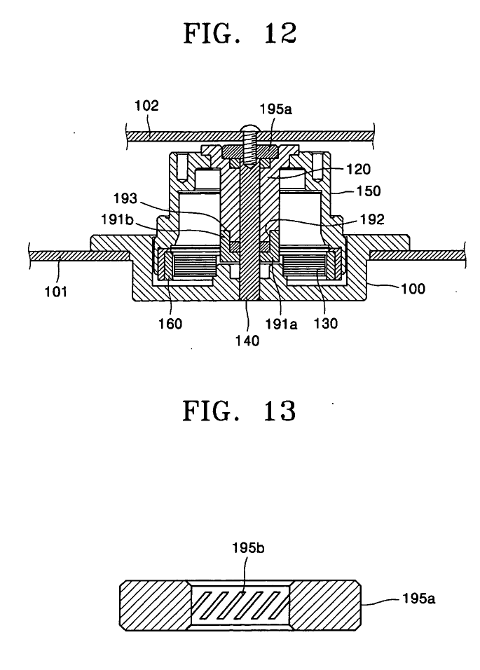

In addition, in the fluid dynamic bearing motor illustrated in FIG. 11, flow grooves 195b for forming a fluid dynamic pressure using injected oil are formed on inner surfaces of the cover plate 195a and the lower hydrodynamic pressure cover 191, as shown in FIG. 13.

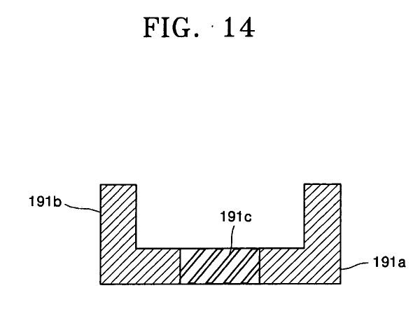

Referring to FIGS. 12 and 14 illustrating a fluid dynamic bearing motor according to another embodiment of the present invention, the annular lower hydrodynamic pressure cover 191a fixed to the shaft 140 has an upwardly extending portion 191b along an edge thereof and the sleeve 120 has an accommodating groove in which the extending portion 191b is accommodated, such that a journal fluid dynamic bearing 192 and a thrust fluid dynamic bearing 193 are formed between the sleeve 120 and the extending portion 191b. Since other elements are similar to those in FIG. 11, a detailed explanation will not be given.

In addition, referring to FIG. 12, flow grooves 195b and 191c for forming a fluid dynamic pressure using injected oil are formed on inner surfaces of the cover plate 195a and the extending portion 191b of the lower hydrodynamic pressure cover 191a, as shown in FIGS. 5 and 6.

In the above embodiments, flow grooves (not shown) that form a fluid dynamic pressure using injected oil are formed on an outer circumferential surface of the shaft 140 or an inner surface of the sleeve 120.

In the fluid dynamic bearing motors illustrated in FIGS. 11 and 12, when the cover plate 195a rotates relative to the shaft 140, oil filled in the flow grooves 195b moves toward lower end portions of the flow grooves 195b where a pressure is high, such that oil leakage is prevented and an internal pressure is increased, thereby generating a stable fluid dynamic pressure.

Further, the internal pressure is improved and oil pressure is balanced at the upper and lower portions by virtue of the cover plate 195a and the lower hydrodynamic pressure covers 191 and 191a, thereby preventing oil leakage and vibration.

In the meantime, fluid passage grooves (not shown) that generate a hydrodynamic pressure by forming oil passages are formed on top and bottom surfaces or opposite surfaces of each of the upper and lower thrust plates 171 and 172. The fluid passage grooves may have a herringbone or spiral shape.

If the core 130 in the motor constructed as above is turned on, a rotating member constituted by the sleeve 120, the hub 150, and the rotor 160 rotates relative to a fixing member constituted by the housing 100, the shaft 140, and the stator 130.

Platters, which are information media, are mounted at regular intervals on the hub 150, and rotate together with the hub 150 relative to the fixed shaft 140 to record or read information using recording and/or reading means, such as a magnetic head or light emission.

Oil filled in the fixed shaft 140 and the rotating sleeve 120 forms a high pressure and a fluid dynamic bearing in a journal direction.

In the fluid dynamic bearing motor, since the shaft 140, which has a shorter diameter, a greater length, and a lower stiffness than other components, is used as the fixed body and the hub 150 on which the plurality of platters 200 are mounted is used as the rotating body, vibration caused by stiffness reduction during rotation is prevented. Also, since the shaft 140 is used as the fixed body, stiffness is enhanced and thus the plurality of platters 200 can be mounted, thereby making it possible to record a great amount of information.

Fluid dynamic bearings in a thrust direction are formed between the upper and lower thrust plates 171 and 172 and the sleeve 120.

Further, since oil in the flow grooves 195b of the rotating hydrodynamic pressure cover 195a flows inwardly, the internal pressure between the sleeve 120 and the shaft 140 increases and oil leakage is prevented.

Since the fluid dynamic bearing motor employs one pair of thrust fluid dynamic bearings made by the thrust plates 171 and 172 on the upper and lower portions of the shaft, the fluid dynamic bearing motor can have the same load support force and smaller thrust plates 171 and 172 as compared with an equivalent motor employing one thrust fluid dynamic bearing.

Accordingly, when outer diameters of the thrust plates 171 and 172 decrease, a relative speed of the sleeve is reduced, thereby reducing heat generation and power consumption.

As described above, the fluid dynamic bearing motor has the following advantages.

First, since the journal fluid dynamic bearing is employed at the journal portion of the shaft facing the sleeve and the one pair of thrust fluid dynamic bearings are employed at the upper and lower portions of the shaft, the fluid dynamic bearing motor can have the same load support force as a conventional motor and can prevent conical vibration of the shaft and reduce heat generation and power consumption by reducing the speed of the thrust plates, which form the thrust fluid dynamic bearings, relative to the sleeve.

Second, since the hydrodynamic pressure cover for forming a fluid dynamic pressure is coupled to the upper end portion of the sleeve to which the shaft is rotatably inserted, the internal pressure of the fluid dynamic bearing increases and oil leakage is effectively prevented.

Moreover, since the hydrodynamic pressure cover for forming a fluid dynamic pressure is coupled to the opening portion of the sleeve that rotates relative to the shaft, the internal pressure of the fluid dynamic bearing increases and oil leakage is effectively prevented.

Third, since the oil storage space or the air bubble collector is disposed at the portions, namely, the thrust plates and the axial groove of the shaft, where a pressure is lower than other fluid dynamic bearing portions, the shaft can be driven more effectively.

Fourth, since the upper end portion of the shaft 140 is integrally formed with the hub 150, the motor is conveniently assembled, the number of components is reduced, and the components are easily managed.

Fifth, since the annular rib 182 forming the accommodating groove 181 in which the lower end portion of the shaft 140 and the lower thrust plate 172 are accommodated is formed on the top surface of the cover block 180, and the coupling groove 123 to which the annular rib 182 is coupled is formed on the lower end portion of the sleeve 120, the journal portion is lengthened without changing the size of the sleeve 120 and the hub 150, thereby allowing a greater load support force.

Sixth, since the shaft 140, which has a shorter diameter, a greater length, and a lower stiffness than other components, is used as the fixed body, vibration caused by stiffness reduction of the rotating body during rotation is prevented. Additionally, since the shaft 140 is used as the fixed body, stiffness is enhanced and thus the plurality of platters 200 can be mounted, thereby enabling a greater amount of information to be recorded.

Wile the present invention has been particularly shown and described with reference to exemplary embodiments thereof, it will be understood by those of ordinary skill in the art that various changes in form and details may be made therein without departing from the spirit and scope of the present invention as defined by the following claims.

1. A fluid dynamic bearing motor comprising:
a housing to which a core with a coil wound around it, a sleeve having an axial hole at a central portion thereof, and a cover block supporting the sleeve are fixed;
a shaft rotatably inserted into the axial hole to form an oil gap with the hole;
a hub fixed to an upper end portion of the shaft and having a downwardly extending portion to an inner surface of which a magnet generating an electromagnetic force through an interaction with the core is attached; and
circular thrust plates respectively fixed to upper and lower portions of the shaft,
wherein receiving grooves are formed on an inner portion of the sleeve and accommodate the thrust plates to form fluid dynamic bearing surfaces.

2. The fluid dynamic bearing motor of claim 1, further comprising a hydrodynamic pressure cover fixed to an upper end of the inner portion of the sleeve such that the shaft is rotatably coupled to the hydrodynamic pressure cover, the hydrodynamic pressure cover forming an oil gap with the upper thrust plate and having a plurality of inclined grooves formed at regular intervals on an inner portion thereof.

3. The fluid dynamic bearing motor of claim 1, further comprising fluid passage grooves formed on top and bottom surfaces of the upper and lower thrust plates or on the sleeve and the hydrodynamic pressure cover corresponding to the top and bottom surfaces to generate a hydrodynamic pressure by forming oil passages.

4. The fluid dynamic bearing motor of claim 3, wherein the fluid passage grooves have a herringbone shape.

5. The fluid dynamic bearing motor of claim 3, wherein the fluid passage grooves have a spiral shape.

6. The fluid dynamic bearing motor of claim 1, further comprising oil grooves formed on inner portions of the upper and lower thrust plates to collect air bubbles between the inner portions and the shaft.

7. The fluid dynamic bearing motor of claim 1, wherein the hub is integrally formed with the upper end portion of the shaft.

8. The fluid dynamic bearing motor of claim 1, further comprising:
an inwardly extending hollow flange formed at a central portion of the housing and having an outer circumferential surface to which the core is fixed; and
a cover block inserted into a hollow space of the flange and supporting lower end portions of the shaft, the lower thrust plate, and the hub.

9. The fluid dynamic bearing motor of claim 8, further comprising:
an annular rib formed on a top surface of the cover block and having an accommodating groove that accommodates the lower end portion of the shaft and the lower thrust plate; and
a coupling groove formed on the lower end portion of the sleeve and allowing the annular rib to be coupled thereto.

10. A fluid dynamic bearing motor comprising:
a housing having an inwardly extending hollow flange formed at a central portion thereof;
a core fixed to an outer circumferential surface of the flange and having a coil wound around it;
a cover block inserted into a hollow space of the flange and having an upper end portion protruding into the housing;
a sleeve having a lower end portion fixed to the cover block and also having an axial hole at a central portion thereof;
a shaft rotatably inserted into the axial hole to form an oil gap with the hole;
a hub integrally formed with an upper end portion of the shaft and having a downwardly extending portion to an inner surface of which a magnet generating an electromagnetic force through an interaction with the core is attached;
a circular upper thrust plate fixed to an upper portion of the shaft to rotate together with the shaft and having top and bottom surfaces on which fluid passage grooves are formed to generate a fluid dynamic pressure between the upper thrust plate and the sleeve;
a circular lower thrust plate fixed to a lower portion of the shaft to rotate together with the shaft and having top and bottom surfaces on which fluid passage grooves are formed to generate a fluid dynamic pressure between the sleeve and a top surface of the cover block;
a hydrodynamic pressure cover fixed to an upper end of an inner portion of the sleeve such that the shaft is rotatably coupled to the hydrodynamic pressure cover, the hydrodynamic pressure cover forming an oil gap with a top surface of the upper thrust plate and having a plurality of inclined grooves formed at regular intervals on an inner portion thereof; and
receiving grooves formed on the inner portion of the sleeve and accommodating the upper and lower thrust plates to form fluid dynamic bearing surfaces.

11. A fluid dynamic bearing motor comprising:
a housing having an inwardly extending hollow flange formed at a central portion thereof;
a core fixed to an outer circumferential surface of the flange and having a coil wound around it;
a cover block inserted into a hollow space of the flange and having an upper end portion internally protruding into the housing, the cover block also having a top surface on which an annular rib forming an accommodating groove is formed;
a sleeve having a lower end portion on which a coupling groove coupled to the annular rib of the cover block is formed and having an axial hole at a central portion thereof;
a shaft rotatably inserted into the axial hole to form an oil gap with the hole and having upper and lower portions on outer circumferential surfaces of which flow grooves are formed to generate a fluid dynamic pressure;
a hub integrally formed with an upper end portion of the shaft and having a downwardly extending portion to an inner surface of which a magnet generating an electromagnetic force through an interaction with the core is attached;
a circular upper thrust plate fixed to an upper portion of the shaft to rotate together with the shaft and having top and bottom surfaces on which fluid passage grooves are formed to generate a fluid dynamic pressure between the upper thrust plate and the sleeve by forming oil passages;
a circular lower thrust plate fixed to a lower portion of the shaft to rotate together with the shaft and having top and bottom surfaces on which fluid passage grooves are formed to generate a fluid dynamic pressure between the sleeve and a top surface of the cover block by forming oil passages;
a hydrodynamic pressure cover fixed to an upper end of an inner portion of the sleeve such that the shaft is rotatably coupled to the hydrodynamic pressure cover, the hydrodynamic pressure cover forming an oil gap with a top surface of the upper thrust plate and having inclined grooves at regular intervals formed on an inner portion thereof; and
receiving grooves formed on the inner portion of the sleeve and accommodating the upper and lower thrust plates to form fluid dynamic bearing surfaces.

12. A shaft fixed-type fluid dynamic bearing motor comprising:
a housing to an inner central portion of which an annular stator is fixed;
a shaft having one end fixed to a center of the housing;
a sleeve rotatably coupled to the shaft to form an oil gap with the shaft;
a hub having a central portion coupled to the sleeve to rotate together with the sleeve and also having a downwardly extending portion to an inner surface of which a rotor generating an electromagnetic force through an interaction with the stator is attached; and
circular first and second thrust plates respectively fixed to upper and lower portions of the shaft and forming fluid dynamic bearing surfaces between the first and second thrust plates and the sleeve.

13. The fluid dynamic bearing motor of claim 12, further comprising:
a cover plate fixed to an upper end portion of the sleeve to face the first thrust plate, and rotatably supported on an upper end portion of the shaft; and
an annular lower hydrodynamic pressure cover fixed to a lower end portion of the shaft to face the second thrust plate.

14. The fluid dynamic bearing motor of claim 12, wherein the upper end portion of the shaft is fixed to a fixed body such that both ends of the shaft are fixed.

15. The fluid dynamic bearing motor of claim 13, wherein the cover plate has an inner surface or a corresponding surface of an annular shape on which flow grooves are formed such that the upper end portion of the shaft can pass through the cover plate, and the upper end portion of the shaft is fixed to a fixed body such that both ends of the shaft are fixed.

16. The fluid dynamic bearing motor of claim 13, wherein the annular lower hydrodynamic pressure cover has an upwardly extending portion along an edge thereof, and the sleeve has an accommodating groove in which the extending portion is accommodated, such that a journal fluid dynamic bearing and a thrust fluid dynamic bearing are formed between the sleeve and the extending portion.
